(19) United States
(12) Patent Application Publication
(10) Pub. No.: US 2016/0265248 A1
(43) Pub. Date: Sep. 15, 2016

(54) KEY HAVING AN ENCODING MOVEABLE ELEMENT

(71) Applicants: Ezra SITON, Bnei-Brak (IL); Asher KARPFEN, Jerusalem (IL)

(72) Inventor: ASHER KARPFEN, JERUSALEM (IL)

(21) Appl. No.: 15/032,346

(22) PCT Filed: Oct. 22, 2014
(86) PCT No.: PCT/IL2014/050842

§ 371 Date: Apr. 27, 2016

(30) Foreign Application Priority Data
Oct. 31, 2013 (IL) 229188

(51) Int. Cl. E05B 27/00; E05B 27/08; E05B 19/00; E05B 19/20

(52) U.S. Cl. CPC E05B 27/005; E05B 19/205; E05B 27/0042; E05B 27/08; E05B 19/0011; E05B 19/0017; E05B 27/0021

(57) ABSTRACT

A key (10, 10A), comprising: a blade (20); a plurality of encoding bores (12a, 12b, 12c, 12d, 12e) in the blade (20); and wherein at least one (12d) of the encoding bores is designed to allow a corresponding pin (16d) of a lock (44) thereof to cross an entire thickness (50) of the blade (20), thereby increasing the number of encoding combinations of the lock (44).

### TECHNICAL FIELD

The present invention relates to the field of keys and locks. More particularly, the invention relates to a key and a lock which do not allow certain break-in operations.

### BACKGROUND ART

In traditional cylinder locks, an accepted break-in method is as described below:

Stage A: The thief inserts a “key” with maximal projections (“Key D” below), into which the pins of the cylinder are inserted.

Stage B: The thief moves (“bounces”) the pins to the appropriate heights that allow rotating the cylinder and opening the lock.

The purpose of the invention is to prevent the break-in method described above.

It is an object of the present invention to provide a key and a lock not allowing the break-in technique.

It is an object of the present invention to provide a solution to the above-mentioned and other problems of the prior art.

Other objects and advantages of the invention will become apparent as the description proceeds.

### SUMMARY OF THE INVENTION

A key (10, 10A), comprising:
a blade (20);
a plurality of encoding bores (12a, 12b, 12c, 12d, 12e) in the blade (20); and
wherein at least one (12d) of the encoding bores is designed to allow a corresponding pin (16d) of a lock (44) thereof to cross an entire thickness (50) of the blade (20),
thereby increasing the number of encoding combinations of the lock (44).

Encoding characteristics of the at least one (12d) of the encoding bores, designed to allow a corresponding pin (16d) of a lock (44) thereof to cross an entire thickness (50) of the blade (20), may comprise at least location of the bore, and depth of the bore.

The at least one (12c) of the encoding bores, designed to allow a corresponding pin (16d) of a lock (44) thereof to cross an entire thickness (50) of the blade (20), may comprise a stationary dome (48d), protruding beyond the blade's thickness (50).

The at least one (12c) of the encoding bores, designed to allow a corresponding pin (16d) of a lock (44) thereof to cross an entire thickness (50) of the blade (20), may comprise a rotatable protrusion (22),
for protruding beyond the blade's thickness (50) in at least one disposition of the key (10A), for opening a lock (44), and for not protruding beyond the blade's thickness (50) in other dispositions of the key (10A), for allowing inserting the key (10A) into the lock (44) and for removing the key therefrom.

The encoding characteristics of the at least one (12c) of the encoding bores, designed to allow a corresponding pin (16d) of a lock (44) thereof to cross an entire thickness (50) of the blade (20), may comprise at least the height of the rotatable protrusion (22), and direction of rotation of the rotatable protrusion (22).

The invention is directed to a lock (44) for the key (10, 10A), the lock comprising an indentation (34) encoded for housing the rotatable protrusion (22) for opening the lock (44).

The indentation (34) may comprise a diagonal wall (34A), for rotating the rotatable protrusion (22) to a non-protruding position, for allowing inserting the key (10A) into the lock (44) and for removing the key therefrom.

The rotatable protrusion (22) may be operable for determining the height of two pins (16d, 16e) of a lock (44), according to the pin (16d) having a stronger spring (18d).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 is a two-dimensional cross-section schema of the encoding bores of a prior art key of a familiar type.

FIG. 1A is a two-dimensional cross-section schema of the prior art key of FIG. 1 being inserted into the corresponding prior art cylinder.

FIG. 2 is a two-dimensional cross-section schema of the prior art encoding pins of the prior art cylinder of FIG. 1A to which the prior art key of FIG. 1 fits, and a prior art break-in key, used for breaking into this prior art cylinder.

FIG. 3 describes the second stage that follows the first stage in FIG. 2.

FIG. 4 describes the two-dimensional cross-section schema of a key structure, according to one configuration of the current invention, which does not enable the break-in method described in FIGS. 2 and 3.

FIG. 5 describes a two-dimensional schema from a front view of the cylinder that has two slots in the drum, in order that it should suit the key described in FIG. 4.

FIG. 5A describes a key structure, according to another configuration of the current invention, which does not enable the break-in method described in FIGS. 2 and 3.

FIG. 6 is a two-dimensional cross-section schema of the key of FIG. 5A when it is disposed inside the lock.

FIG. 7 describes FIG. 6, when the user begins removing the key from the drum.

FIG. 8 describes the two-dimensional cross-section schema of the structure of the key when it is in the lock, describing various encoding parameters using the rotatable protrusion method described in FIG. 7.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

The solution of the invention is encoding of protrusions, meaning that the encoding comprises a protrusion or protrusions beyond the thickness of the key blade.

The result is that it is not possible to perform stages A and B described in the background chapter.

One configuration is encoding by means of fixed protrusions. For example, if a key that has only projections has five possible depths for each projection, i.e., five possibilities for each bore, henceforth additional encodings of protrusions are added. For example, two heights of protrusions, adding up to 5+2=7 possibilities.

One of the disadvantages of fixed protrusions is that it is problematic to insert and remove the key. An additional disadvantage is that the protrusion is only from one side.

Another configuration that solves the above problems is that the encoding of the protrusion or protrusions is active only once the key is inserted, i.e., by means of a rotatable protrusion.

The rotatable protrusion configuration achieves encoding that protrudes from both sides of the key.

For example, if a key that has only projections has five possible depths for each projection, i.e., five possibilities for each bore, additional encodings of protrusions are now added. For example, two heights of protrusions from both sides, giving 2+2+5=9 possibilities.

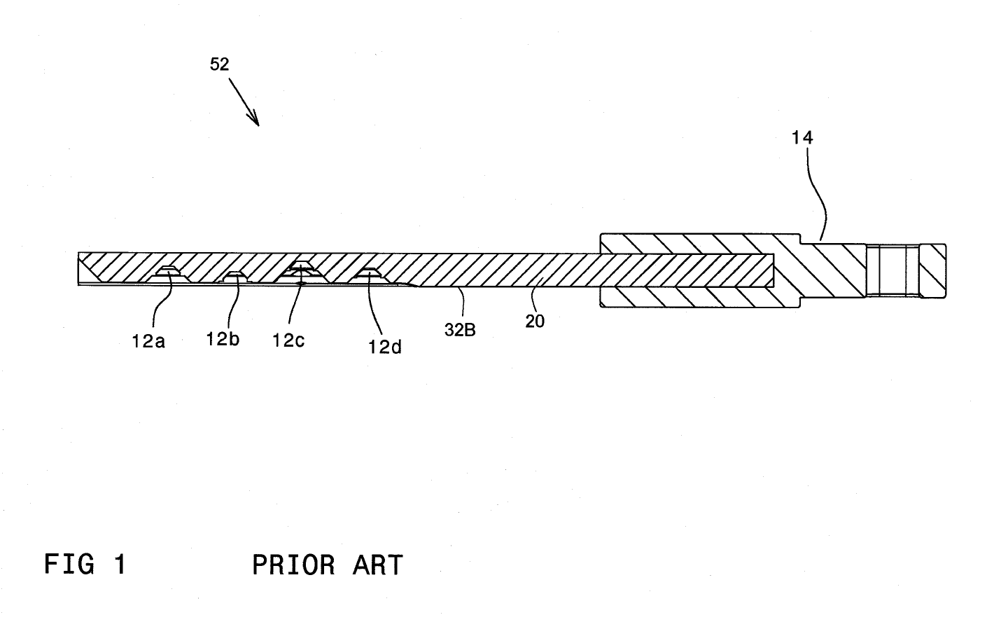

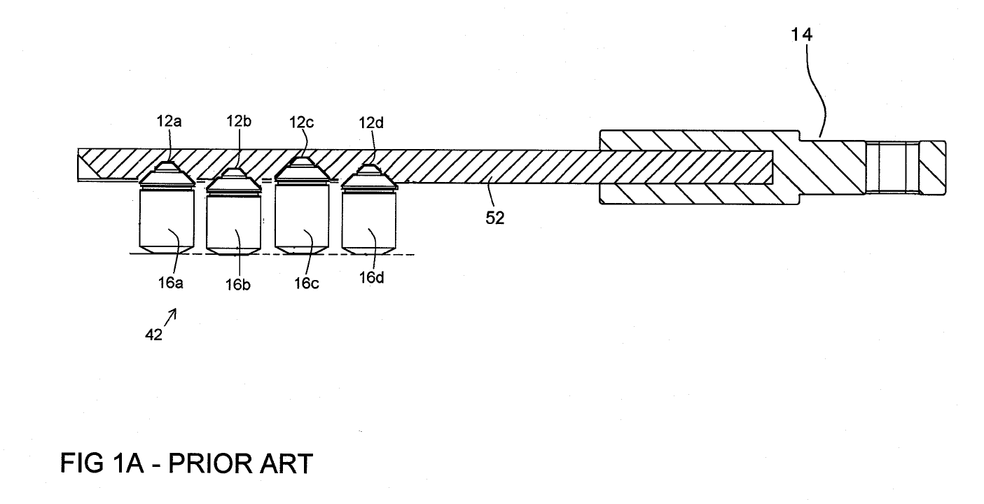

FIG. 1 is a two-dimensional cross-section schema of the encoding bores of a prior art key of a familiar type.

The figure depicts a cross-section of a prior art key (52) and the key handle (14). Key (52) has encoding bores (12a,12b,12c,12d) engraved on the side 32B of the surface of the blade (20). The depth of the bores is different. For example, bore (12c) is deeper than the other bores (12b,12d,12a).

FIG. 1A is a two-dimensional cross-section schema of the prior art key of FIG. 1 being inserted into the corresponding prior art cylinder.

The combination of the depth of the bores (12a,12b,12c,12d) defines the key code, fitting the code of the corresponding prior art cylinder 42.

In this state, of the encoding pins (16a,16b,16c,16d) of cylinder 42 entering into bores (12a,12b,12c,12d) of the prior art key (52), the encoding pins (16a,16b,16c,16d) of cylinder 42 correspond to encoding bores (12a,12b,12c,12d) of prior art key 52. Thus, the encoding pins (16a,16b,16c,16d) of cylinder 42 allow rotation of the drum (not shown), since in this situation, a shear line 26 exists at the other end of the encoding pins (16a,16b,16c,16d).

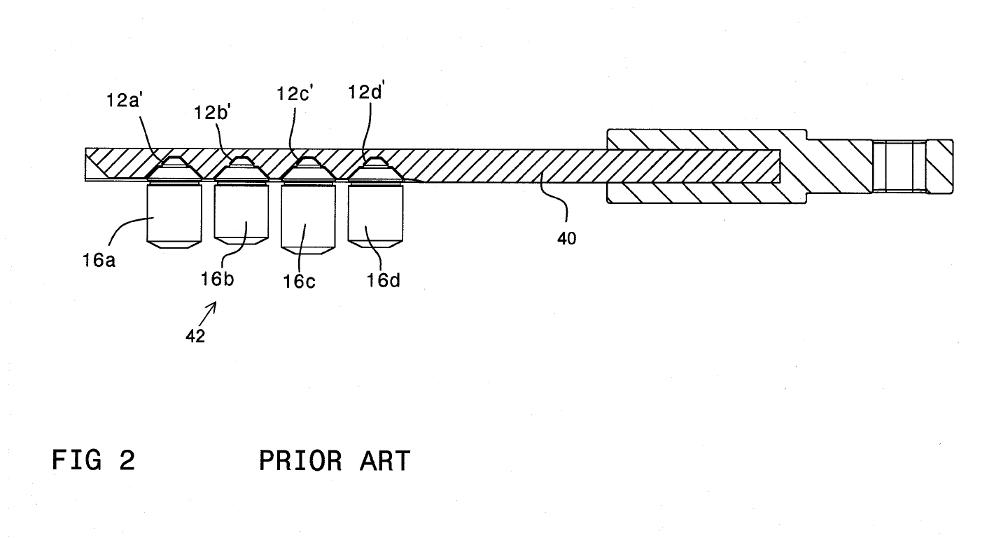

FIG. 2 is a two-dimensional cross-section schema of the prior art encoding pins of the prior art cylinder of FIG. 1A to which the prior art key of FIG. 1 fits, and a prior art break-in key, used for breaking into this prior art cylinder.

A break-in key 40, used by a person not having key 52 and the key code thereof, constitutes a key being similar to prior art key 52. However, unlike key 52 having encoding bores (12a,12b,12c,12d) having different depths, in break-in key 40, all of the bores (12a′,12b′,12c′,12d′) are bored in at a maximal depth.

At the first step, break-in key 40 is inserted into the cylinder 42, to which the prior art key of FIG. 1 fits. Since all of the bores (12a′,12b′,12c′,12d′) of break-in key 40 are bored at the maximal depth, encoding pins (16a,16b,16c,16d) of cylinder 42 enter the maximal depth into bores (12a′,12b′,12c′,12d′) of break-in key 40.

In this state, of entering the maximal depth into bores (12a′,12b′,12c′,12b′) of break-in key 40, the encoding pins (16a,16b,16c,16d) of cylinder 42 do not correspond to encoding bores (12a,12b,12c,12d) of key 52 of FIG. 1. Thus, the encoding pins (16a,16b,16c,16d) of cylinder 42 do not allow rotation of the drum (not shown). This, since in this situation, a shear line does not yet exist, and it is not yet possible to rotate the cylinder 42.

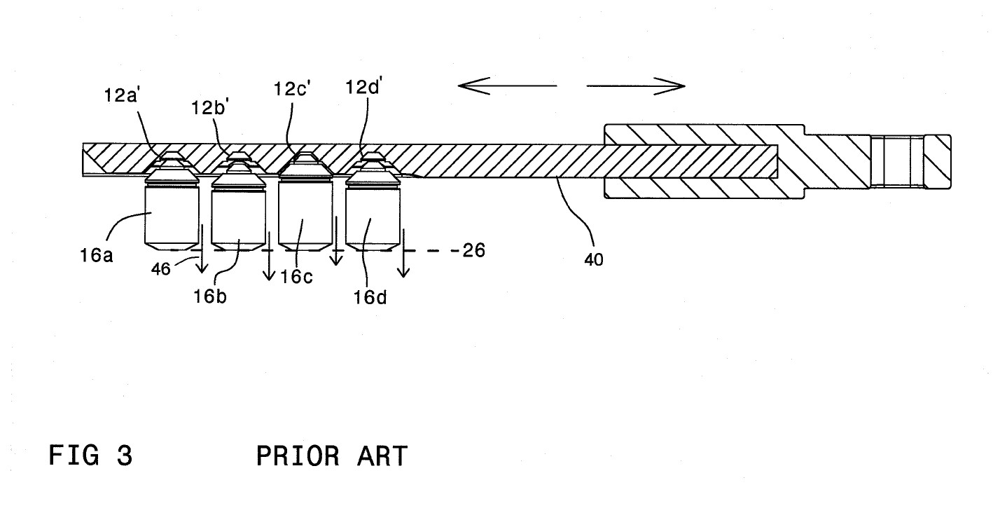

FIG. 3 describes the second stage that follows the first stage in FIG. 2.

In the second stage, the thief draws the encoding pins (16a,16b,16c,16d) away along the direction enumerated 46, from the bores (12a′, 12b′, 12c′, 12d′) to a location that is suitable for the encoding in the cylinder, i.e., the ends of encoding pins (16a,16b,16c,16d) approach the shear line (26) and enable opening the cylinder 42.

The method of drawing the encoding pins (16a,16b,16c,16d) away is typically applied in these locks by shaking, bouncing, or inserting and removing of break-in key 40, while applying pressure for rotating the cylinder drum.

The invention is directed to a key and a lock 44 adapted thereto, for preventing this break-in method.

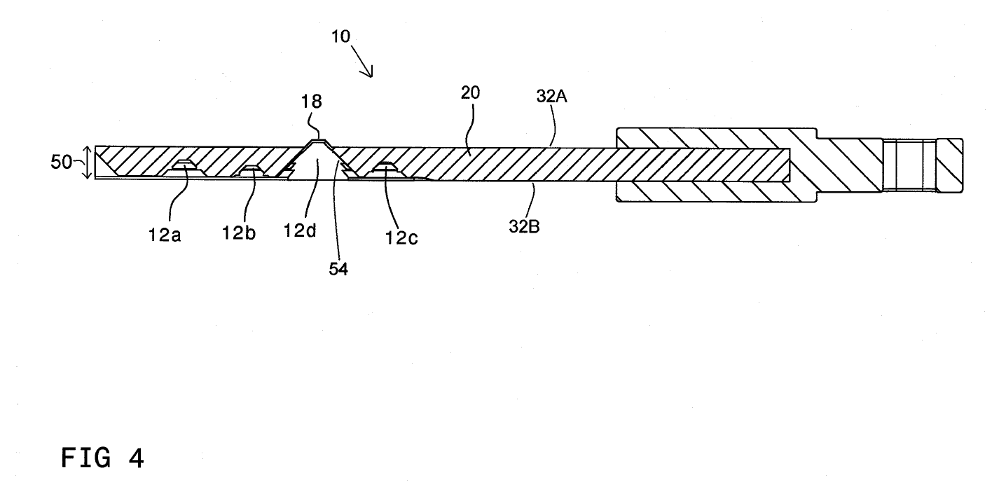

FIG. 4 describes the two-dimensional cross-section schema of a key structure, according to one configuration of the current invention, which does not enable the break-in method described in FIGS. 2 and 3.

In order for the key (10) not to enable the break-in method described in FIG. 3, the encoding bores in the key (12a,12b,12c,12d) contain at least one bore (12d) characterized in allowing the corresponding pin (16d) of the lock 44 to cross the entire thickness 50 of the blade 20 and even further. Bore 12d may be regarded as being deeper than the thickness 50 of the blade 20. Thus, bore 12d extends beyond the side surface 32A of key 10. This depth forms a dome (48d) that protrudes out to side 32A of the key (10).

This key (10) does not enable the break-in method described in FIGS. 2 and 3, because pin 16d must move into bore 12d opposite to the direction (46 in FIG. 3) that the pins move in the second stage; however, the break-in key (40) of FIGS. 2 and 3) does not enable pin 16d move there.

If bore 12d would have been unchangeable in all the keys of this inventive type, i.e., would not be part of the encoding, the thief would have been able to prepare a break-in key 40 that would contain this deep bore 12d, so that the break-in key 40 would be able to move in this opposite direction. However, the thief cannot prepare such a uniform key, because, according to the present invention, the location of this deep bore varies between the key 10 to key 40, and/or its height may vary.

In contrast to the prior art, key 52 having encoding limited to the thickness of the blade, the inventive key 10 adds combinations of encoding which are not limited to the thickness, since the depth of bore 12d exceeds the thickness 50 of the blade.

The disadvantages of this method are

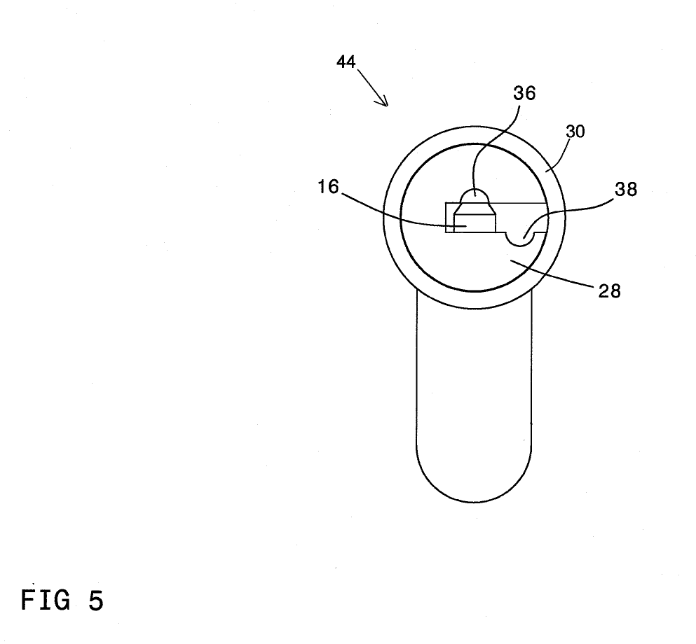

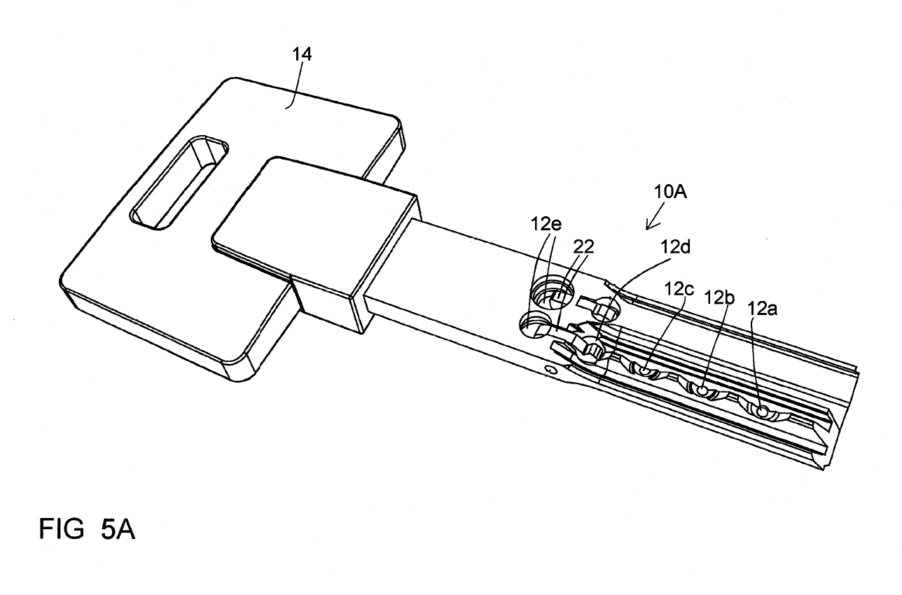

a. It is difficult to produce such a key (10) that has a protrusion. For a symmetrical key, allowing inserting the key straight or upside-down, as enabled by present day keys, the dome 48d must also be present on the other side (32B). This is even more problematic.
b. It is difficult to release the pin from the deep bore 12d. Indeed, it can be done with a sufficient incline 54 in key 10. However, the sufficient incline occupies volume, and also it is a source of lack of reliability.
c. The third disadvantage is described in FIG. 5.

FIG. 5 describes a two-dimensional schema from a front view of the cylinder that has two slots in the drum, in order that it should suit the key described in FIG. 4.

The third disadvantage of the key in FIG. 4 is that the drum (28) must contain a slot (36) along its entire length, for allowing the dome (48d) to move inside the drum (28). It then provides access to the thief to insert a break-in key. For a symmetrical opening, enabled by today's keys, two such slots are needed, each on a different plane.

The drum (28) in the cylinder (30) contains two slots (36, 38). These slots must be in the drum (28) in order for the key 10 having projections 48d to enter the slot (36) of the drum (28) and leave it. Also, it is possible to see the first encoding pin (16).

FIG. 5A describes a key structure, according to another configuration of the current invention, which does not enable the break-in method described in FIGS. 2 and 3.

A key (10A) according to this embodiment of the present invention, includes, instead of the stationary dome (48d) of FIG. 4 covering the bore (12d in FIG. 4), a protrusion (22) being rotatable about a hinge (24) for covering the bore (12d and 12e in FIG. 5A). Like stationary dome (48d) of FIG. 4, the rotatable protrusion (22) as well protrudes into the drum (28), and serves as part of the code of the key (10A).

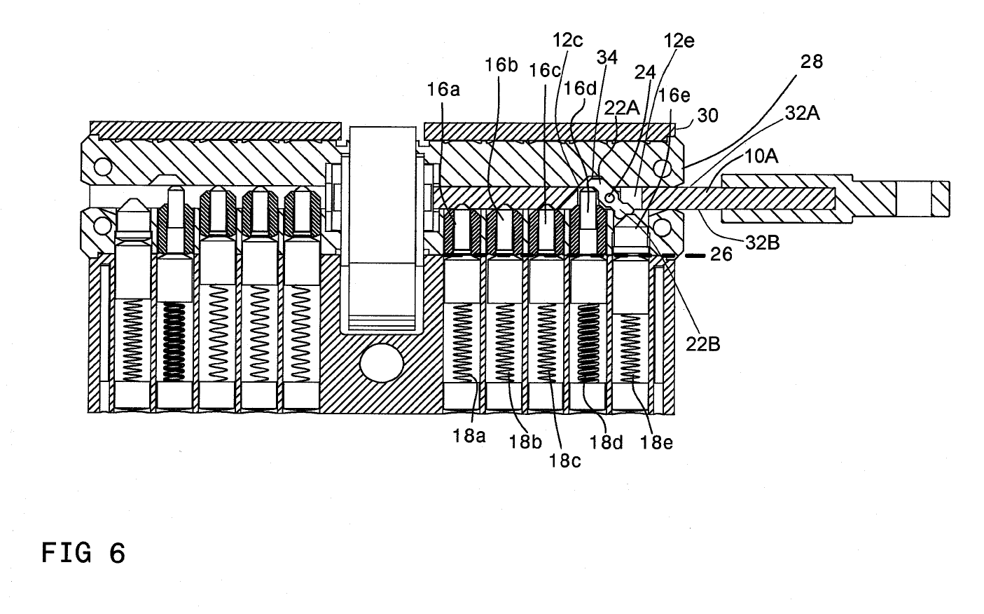

FIG. 6 is a two-dimensional cross-section schema of the key of FIG. 5A when it is disposed inside the lock.

The rotatable protrusion (22) enters the cylinder drum (28) at a tilted position.

A spring (18d) lifts encoding pin (16d). Spring 18d is designed to be stronger than spring 18e and other springs (18a,18b,18c,18e). Thus, encoding pin (16d) lifts one side (22A) of rotatable protrusion 22 beyond side 32A, and lowers the other side (22B) of rotatable protrusion 22 about a hinge 24. The lowering of side 22B presses encoding pin (16e), thus pushing the pin (16e) downwards.

This action creates additional encoding between the rotatable protrusion (22) and pins (16d) and (16e), and enables pin (16d) to penetrate to the depth that is beyond the thickness 50 of the key, thus avoiding the break-in burglary technique in the customary method (described in FIG. 3). This is in contrast to key 52 of FIG. 3.

The other encoding pins (16a, 16b, 16c), and springs (18a, 18b, 18c) are similar to those of the prior art cylinder (42 in FIG. 1A).

Rotatable protrusion (22) is advantaged over the stationary dome (48d) of FIG. 4 in that the drum (30) requires an indentation 34 only on top of the rotatable protrusion (22) at the appropriate location, and does not require slot (36) along the entire length of the drum (30), as in FIG. 5. This is because when the key (10A) is pulled outwards, the drum (28) presses on the upper side 22A of the rotatable protrusion (22) onto pin (16d), thus releasing the pin (16d) out of indentation 34.

Description of the mechanism: The left spring (18d) is stronger than the right spring (16e). Therefore, when the key (10) is disposed inside, the strong spring (18d) dictates the direction of the inflection of the rotatable protrusion (22) to the position depicted in FIG. 6.

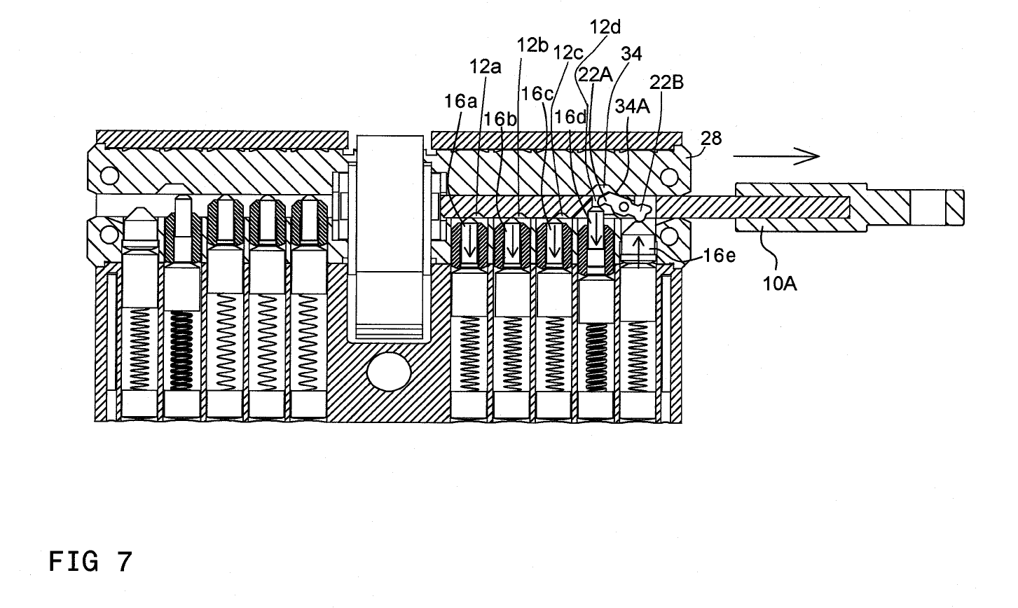

FIG. 7 describes FIG. 6, when the user begins removing the key from the drum.

Upon pulling the key (10) out of the drum (28), the upper side 22A of the rotatable protrusion (22) collides with the diagonal wall 34A of the indentation 34 of the drum (28), and presses the upper side 22A of the rotatable protrusion (22) to descend towards the lower pin (16d). The lower side (22B) of the rotatable protrusion (22) rises and enables pin (16e) to rise.

The descending of upper side 22A of rotatable protrusion (22) by the diagonal wall of indentation 34 is enabled similar to the releasing downwards of the other encoding pins (16a, 16b, 16c) that were inserted in low depth, via the thrust of the conical part into the bores of the key (10).

According to another embodiment, the left spring (18d) may be weaker than the right spring (16e), and therefore when the key (10) is housed inside, the right spring (18e) is the strong one that dictates the direction of the inclination of the rotatable protrusion (22), causing the inclination to be reversed, thus reversing the encoding and adding encoding possibilities.

The rotatable protrusion 22 is releasable by the diagonal wall of indentation 34 of drum 28, even in the case that the rotatable protrusion 22 protrudes towards the drum 28 at the external side (right in the figure) of the key 10A.

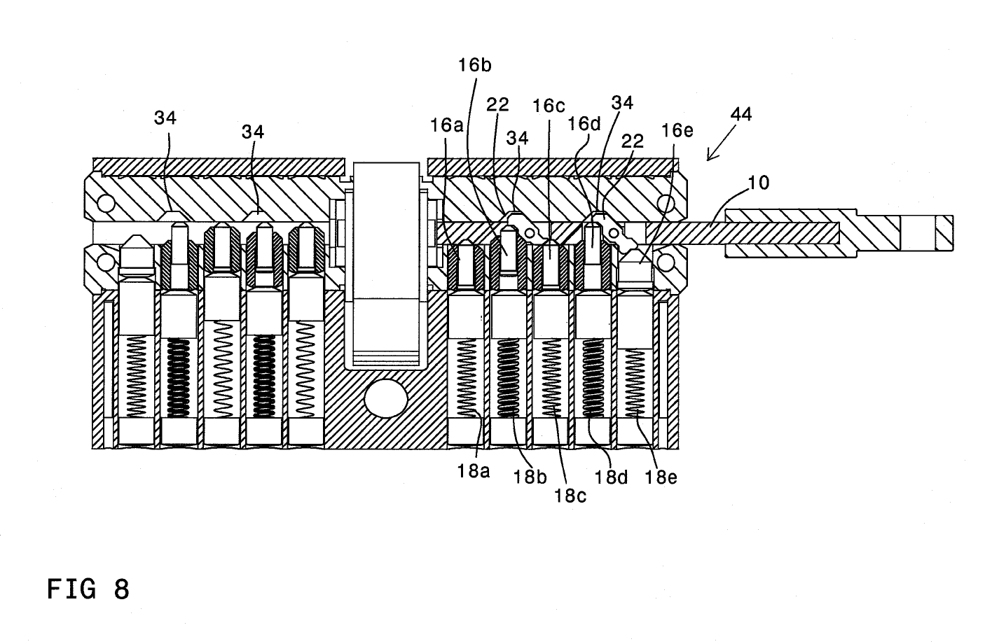

FIG. 8 describes the two-dimensional cross-section schema of the structure of the key when it is in the lock, describing various encoding parameters using the rotatable protrusion method described in FIG. 7.

The figure shows an example of the key (10A) having two encoding rotatable protrusions (22). This example depicts that another parameter of the encoding is the location of the rotatable protrusion 22 in relation to the key 10A.

An additional parameter is the height of the rotatable protrusion (22). FIG. 8 depicts that concerning the upper pins (16b, 16d), each presses a different rotatable protrusion (22), and each reaches a different depth (pin 16d may insert deeper than pin 16b in the example).

Similarly, concerning the lower pins (16c, 16e) at the lower sides of the rotatable protrusions (22), each reaches a different depth. So there is encoding in the protrusions from both sides of the key.

An additional parameter is the location and depth of the indentation (34) in the drum (28).

When the key (10) is inserted into the drum (28), the rotatable protrusions (22) rise into the indentations (34) inside the drum (28), and it is part of the encoding of the cylinder. When the rotatable protrusions (22) ascend, a place is vacated for the long encoding pins (16b, 16d) to rise and surpass the height of the key (10), with the back side of the rotatable protrusion encoding pins (16e, 16c). The other encoding pins (16a) encode the familiar encoding method.

Thus, referring to FIG. 4, the key (10A) includes, in at least one location, a bore (12d), whose location on the key depends on the encoding. Thus, the encoding of this key (10A) does not have a maximal depth, thereby, it is not possible to open the lock 44 adjusted for this key, using a break-in key (40) having a depth close to the depth of the key.

The bore (12d) may further include a dome (48d) that covers the bore (12d), wherein the height of the dome (48d) is a function of the encoding.

The key (10A) may further include: an additional dome (48d) disposed on the second side of the key, the additional dome (48d) for covering the other bore (12d), wherein the height of the projection depends on the encoding.

The said dome (48d) may be stationary on the key.

Said dome (48d) may constitute a rotatable protrusion body (22), being rotatable about a hinge (24).

Said rotatable protrusion (22) protrudes only when facing the indentation (34) of the drum (28). The hinge (24) allows the rotatable protrusion (22) to be disposed parallel to the blade, for not protruding out, thus allowing inserting and removing the key (10A) from the lock 44.

The rotation direction of the rotatable protrusion (22) is a function of the encoding.

In the figures and/or description herein, the following reference numerals (Reference Signs List) have been mentioned:
numeral 10 denotes a key, according to one embodiment of the present invention;
numeral 10A denotes a key, according to another embodiment of the present invention;
numerals 12a,12b,12c,12d,12e denote encoding bores of the key;
numeral 14 denotes the handle of the key;
numerals 16a,16b,16c,16d denote encoding pins of the cylinder or of the drum;
numerals 18a, 18b, 18c, 18d, and 18e denote springs of the lock, for pressing the pins of the lock towards the bores of the key;
numeral 20 denotes the blade of the key;
numeral 22 denotes a rotatable protrusion;
numeral 22A denotes the upper side of the rotatable protrusion;
numeral 22B denotes the lower side of the rotatable protrusion;
numeral 24 denotes a hinge about which the rotatable protrusion is rotatable;
numeral 26 denotes a line, indicating the shear line of the drum rotating in relation to the cylinder;
numeral 28 denotes the drum of the lock;
numeral 30 denotes the cylinder of the lock;
numerals 32A and 32B denote surface sides of the key;
numeral 34 denotes an indentation in the drum of the lock;
numeral 34A denotes a diagonal wall of the indentation;
numerals 36 and 38 denote slots in the drum;
numeral 40 denotes a break-in key;
numeral 42 denotes a prior art cylinder;
numeral 44 denotes the lock, including the cylinder and the drum;
numeral 46 denotes a direction;
numeral 48d denotes a stationary protrusion on the key, shaped as a dome for receiving a pin of the lock;
numeral 50 denotes the thickness of the key, excluding the inventive protrusions thereof;
numeral 52 denotes a prior art key; and
numeral 54 denotes an incline in the key, for allowing releasing the pins of the lock therefrom upon drawing the key out of the lock.

In the description herein, the following references have been mentioned:

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A key, comprising:
a blade;
a plurality of encoding bores in said blade; and
wherein at least one of said encoding bores is designed to allow a corresponding pin of a lock thereof to cross an entire thickness of the blade, thereby increasing the number of encoding combinations of said lock.

2. A key according to claim 1, wherein encoding characteristics of said at least one of said encoding bores, designed to allow a corresponding pin of a lock thereof to cross an entire thickness of the blade, comprises at least one member selected from a group including: location of the bore, depth of the bore.

3. A key according to claim 1, wherein said at least one of said encoding bores, designed to allow a corresponding pin of a lock thereof to cross an entire thickness of the blade, comprises a stationary dome, protruding beyond the blade's thickness.

4. A key according to claim 1, wherein said at least one of said encoding bores, designed to allow a corresponding pin of a lock thereof to cross an entire thickness of the blade, comprises a rotatable protrusion, for protruding beyond the blade's thickness in at least one disposition of the key, for opening a lock, and for not protruding beyond the blade's thickness in other dispositions of the key, for allowing inserting the key into the lock and for removing the key therefrom.

5. A key according to claim 4, wherein said encoding characteristics of said at least one of said encoding bores, designed to allow a corresponding pin of a lock thereof to cross an entire thickness of the blade, comprises at least one member selected from a group including: height of said rotatable protrusion, direction of rotation of said rotatable protrusion.

6. A lock for a key according to claim 4, comprising an indentation encoded for housing said rotatable protrusion for opening the lock.

7. A lock according to claim 6, wherein said indentation comprises a diagonal wall, for rotating said rotatable protrusion to a non-protruding position, for allowing inserting the key into the lock and for removing the key therefrom.

8. A key according to claim 4, wherein said rotatable protrusion is operable for determining the height of two pins of a lock, according to the pin having a stronger spring.
